(19) United States
(12) Patent Application Publication
(10) Pub. No.: US 2015/0224953 A1
(43) Pub. Date: Aug. 13, 2015

(54) ROLL-BAR COVER

(71) Applicant: K.L. Kaschier-und Laminier GmbH

(72) Inventor: Albert RORING, Gronau-Epe (DE)

(21) Appl. No.: 14/604,706

(22) Filed: Jan. 24, 2015

(30) Foreign Application Priority Data
Feb. 12, 2014 (DE) 102014001793.1

(51) Int. Cl. B60R 21/13; B62D 25/24

(52) U.S. Cl. CPC B60R 21/13; B62D 25/24

(57) ABSTRACT

A cover for a motor-vehicle body-panel hole through which a rollover body can be raised. The cover has a rigid flap engaged over the hole and having a plurality of edges, and a textile fixed to and extending over the flap, across the edges, and over adjacent regions of the body panel. The textile is constructed such that, on upward movement of the panel caused by raising of the rollover body, the textile ruptures at all but one of the edges and remains intact to form a hinge at the one edge for upward pivoting of the flap at the one edge.

### CROSS REFERENCE TO RELATED APPLICATIONS

This application is related to copending application Ser. No. 14/345,362 filed 17 Mar. 2014, whose entire disclosure is incorporated by reference.

### FIELD OF THE INVENTION

The present invention relates to a raisable rollover-protection element. More particularly this invention concerns a cover for such a rollover-protection element.

### BACKGROUND OF THE INVENTION

It is known to provide a car body of a convertible rearward of the passenger compartment with a raisable rollover body.

As described in EP 1,857,332 a rollover bar is installed in a fixed but height-adjustable manner behind the seats of an automobile. The recess rollover bod is recessed so as not to be visible in the inactive state, but is are actively raised by an actuator in response to detection by a sensor event of a collision. To this end, there is a cutout above the lowered rollover body through which the rollover bar can pass and which is covered by a flap when the rollover body is lowered. In order to ensure that this flap also opens reliably when it has been frozen shut by snow or ice, a mechanical device is provided that opens the flap at the right time as the rollover element is being raised. Such a system is relatively elaborate and prone to functional failures.

### OBJECTS OF THE INVENTION

It is therefore an object of the present invention to provide an improved rollover-protection element cover.

Another object is the provision of such an improved rollover-protection element cover that overcomes the above-given disadvantages, in particular that always opens reliably without additional mechanical moving devices, but that is of simple and inexpensive construction.

### SUMMARY OF THE INVENTION

A cover for a motor-vehicle body-panel hole through which a rollover body can be raised. The cover has according to the invention a rigid flap engaged over the hole and having a plurality of edges, and a textile fixed to and extending over the flap, across the edges, and over adjacent regions of the body panel. The textile is constructed such that, on upward movement of the panel caused by raising of the rollover body, the textile ruptures at all but one of the edges and remains intact to form a hinge at the one edge for upward pivoting of the flap at the one edge.

In other words at least one tear region formed by the flap is provided in the car body for the rollover body that unblocks the hole for the rollover body/rollover bodies. This tear region has a hinge at the one edge, and the other edges of the tear region located outside of the hinge form breaking lines. Such a region, particularly a flap, of simple construction which can be torn open at its edges opens independently of the weather with absolute reliability and, what is more, is invisible in the unopened state. Furthermore, a mechanical opening construction with an actuator is not necessary.

By virtue of the feature that the flap is/are hinged via a textile hinge on the material of the cover flap enclosing the tear region, it is ensured, for one, that there is reliable function and, for another, that the flap does not fly away after being torn open and does not fragment but rather remains firmly on the cover flap.

A flap can be arranged for each rollover body. Moreover, it is advantageous if the cover flap also covers, in addition to the rollover body/rollover bodies, a convertible soft top retracted into the rear region, an automobile roof or automobile roof part.

Reliable function is ensured here if the cover flap has a surface material made of plastic that carries a woven or knitted textile having sacrificial filaments that run substantially at a right angle or transverse to the hinge axis and tear in the hinge region on raising of the rollover body, and the textile also has stop filaments that, on release of the rollover body, permit a pivoting of the flap about the hinge axis without tearing at the hinge in order to securely hold the flap after release of the rollover body.

Here, too, it is advantageous if the non-tearing stop filaments are densely arrayed as waves and/or loops only in the hinge region and therefore are longer there than in the regions offset from the hinge. The region rendered compact by waves and/or loops can be located on and/or below the plane of the textile.

Additional structural and functional improvements are achieved when
the non-tearing stop filaments run straight in the regions outside of the hinge and form intermediate spaces between the individual stop filaments that are so large that the plastic material of the cover flap can extend through them,
within the hinge region, the stop filaments within the textile form a narrow strip of high filament density covering the hinge region and parallel to the hinge axis,
two or more different types of sacrificial filaments exist in the textile of different length and/or strength, so that at least one type of sacrificial filament tears earlier than another type of sacrificial filament upon opening and rotating of the tear region,
when there are three or more different types of sacrificial filament, the types of sacrificial, and filament tear successively over time upon opening.
the textile is provided, particularly adhered, with a coating, particularly a fleece or film.

### BRIEF DESCRIPTION OF THE DRAWING

The above and other objects, features, and advantages will become more readily apparent from the following description, reference being made to the accompanying drawing in which:

FIG. 1 is a sectional and perspective view through a rollover-body cover as the rollover body raises through it;

FIG. 1A is a large-scale section illustrating the construction of the door flap for the cover of this invention; and

FIG. 2 is a view of a detail of the system of this invention.

### SPECIFIC DESCRIPTION OF THE INVENTION

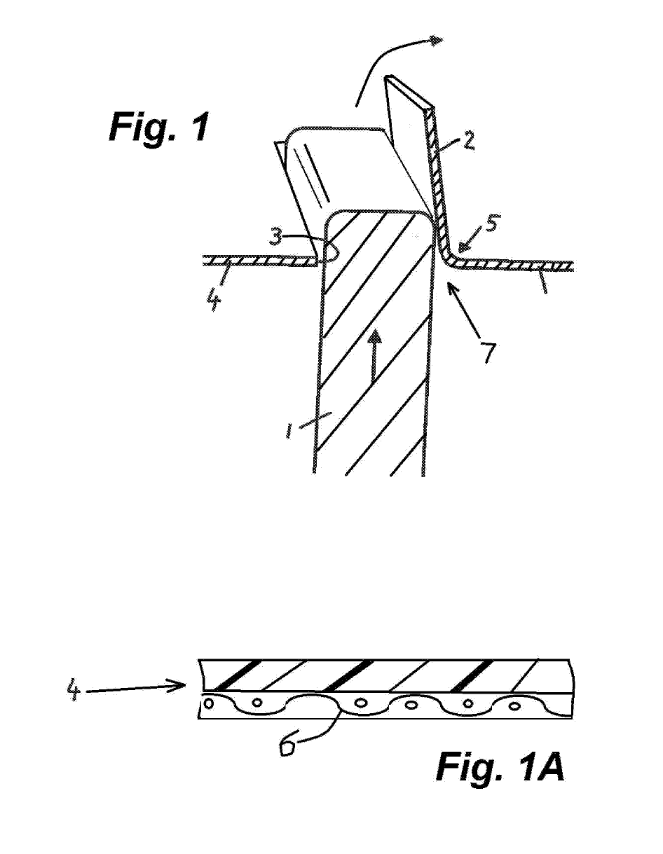

As seen in FIG. 1 shows when a rollover body 1 of an automobile is raised, particularly actively, and, in doing so, passes through a generally rectangular slot or hole 7 in a vehicular body panel 4 and pushes back a door flap 2 normally cover flap and closing this hole 7. During such upward pivoting of the flap 2, it separates around three edges 3 where it was attached to the body panel 4. The tearable edges 3 thus form predetermined breaking lines. Thus a “tear region” is defined by the flap 2.

The flap 2 is also generally rectangular and has, in addition to the three tearable edges 3, a fourth edge provided with a hinge 5 about which the flap 2 pivots upward when it is pushed up by the rollover body 1. To prevent the tear region 2 from being torn off upon pushing-through of the rollover body 1 and to ensure upward pivoting from the body panel 4 with the hinge 5 securely holds the flap 2 attached to the body panel 4, the hinge 5 includes a textile with the characteristics described below.

As shown in FIG. 1A, the flap 4 is cover flap the region 2 is made of a plastic sheet or plate in whose rear side a woven or knitted textile 6 is fused. Instead of being fused in place, the textile 5 can be soaked or coated with plastic in order to form the flap 2 at least in the tear region and around the tear region. In addition, stop filaments 11 and sacrificial filaments 12 are arranged within the textile 6. The purpose of the stop filaments 11 is to securely hold the tear region 2 after tearing and during and after pivoting-up, so that it does not fly away or come loose. The sacrificial filaments 12 are intended to tear in order to enable easy pivoting and folding-up of the tear region 2. However, a sufficiently functional embodiment can be achieved if the sacrificial filaments are omitted.

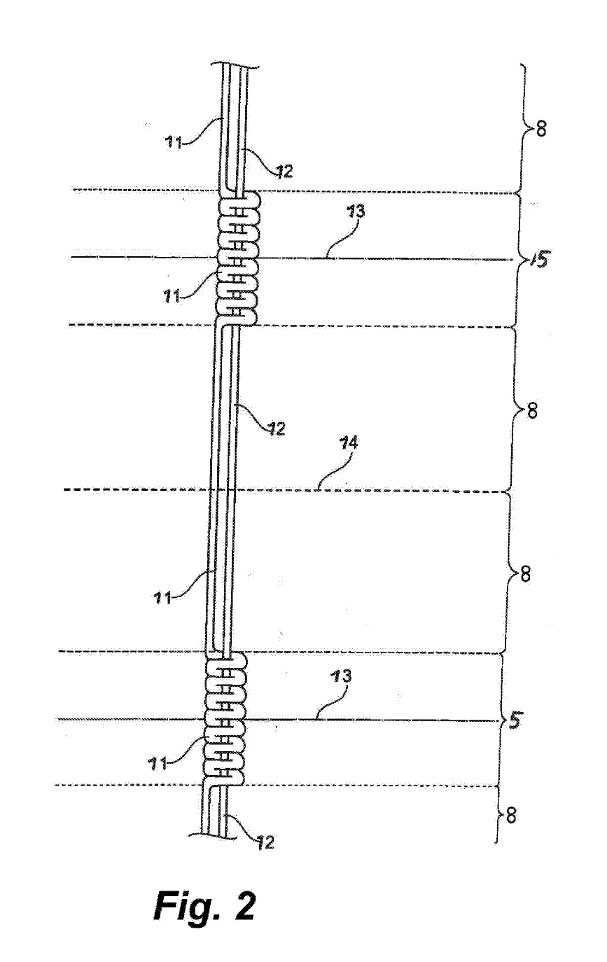

FIG. 2 shows only a single stop-filament 11 with a sacrificial filament 12 next to it extending in the same direction of extension, the other filaments of the textile not being shown. An axis 13 of the hinge lies at a right angle to the direction of extension of the filaments 11 and 12 and on both sides, and the hinge 5 is located on the axis 13. In regions 8 flanking the hinge region 5, the filaments 11 and 12 both extend parallel to each other.

In the hinge region A, the sacrificial filaments 12 extend substantially straight across the hinge axis 13, whereas the stop filaments 11 are compacted in the hinge region A, that is, they have a substantially longer length there than the sacrificial filaments 12. The compaction of the stop filaments 11 is achieved through the arrangement thereof in the manner of waves or loops in the hinge region A. Waves and loops are also understood, however, as including snake-like, meandering, screw-like or angled forms of the stop-filament 11.

On the other hand, the stop filaments 11 run straight in the regions B lying between the hinge regions A in a substantially uncompacted manner and thus substantially parallel to the sacrificial filaments 12, so that the stop filaments are less dense in the regions 8 outside of the hinge region 5, and the plastic material of the flap 2 or of the body panel 5 reaches better between the filaments and adheres the textile better in the plastic.

Preferably, the textile is manufactured as web material with many regions 5 and 8 that succeed one another successively over and over transverse to the web length direction, so that the web material is separated into individual sections after its is manufacture at dividing lines 14, with each section being used for a respective tear flap 2.

In the schematic drawing, the sacrificial filament 12 is shown extending through the loops of the stop-filament 11 in the hinge region A. Instead, however, the sacrificial filament can also lie to the side of the compacted region of the stop-filament or above or below this region.

In another embodiment, different types of sacrificial filament 12 are arranged in a textile. In this way, in addition to the initially tearing sacrificial filaments, there is at least one other type of sacrificial filament which tears later due to its greater strength and/or greater length. Even three or more types can be arranged next to each other in the surface element which increase in strength and/or length from type to type, thus resulting in a continuous successive tearing thereof over time.

The textile used is preferably provided, preferably adhered, with a coating, particularly a fleece or film, before the textile is soaked, coated or fused with plastic.

I claim:

1. A cover for a motor-vehicle body-panel hole through which a rollover body can be raised, the cover comprising:
a rigid flap engaged over the hole and having a plurality of edges; and
a textile fixed to and extending over the flap, across the edges, and over adjacent regions of the body panel, the textile being constructed such that, on upward movement of the panel caused by raising of the rollover body, the textile ruptures at all but one of the edges and remains intact to form a hinge at the one edge for upward pivoting of the flap at the one edge.

2. The cover defined in claim 1, wherein the cover flap is made of plastic and the textile is embedded in the plastic at least at and near the hinge.

3. The cover defined in claim 1, wherein at least one flap is provided for each rollover body.

4. The cover defined in claim 1, wherein the flap also covers a convertible soft top, an automobile roof or automobile roof top.

5. The cover defined in claim 1, wherein the flap is made of plastic and carries the textile that has sacrificial filaments running substantially at a right angle or transverse to the hinge and tearing upon pivoting of the flap away from the hole.

6. The cover defined in claim 5, wherein the textile has nontearing stop filaments that permit pivoting of the flap at the hinge on lifting of the rollover body without tearing in at the one edge in order to securely hold the flap after upward pivoting of the flap.

7. The cover defined in claim 6, wherein the stop filaments (11) are arranged in a compacted, wave-like or loop-like manner only at the hinge (5) and thus have a greater length there than in regions outside the hinge.

8. The cover defined in claim 7, wherein where the filaments are compacted in a wave-like or loop-like manner thy are on or below a plane of the textile.

9. The cover defined in claim 5, wherein the stop filaments run substantially straight outside the hinge and form intermediate spaces between the individual stop filaments that are so large that the plastic material of the cover flap region extends through these intermediate spaces.

10. The cover defined in claim 5, wherein at the hinge, the stop filaments in the textile form a narrow strip of high filament density covering the hinge region and parallel to a pivot axis of the hinge.

11. The cover defined in claim 5, wherein two or more different types of sacrificial filament are provided in the textile of different length or strength so that at least one type of sacrificial filament tears earlier than another type of sacrificial filament upon opening and pivoting of the flap.

12. The cover defined in claim 11, wherein there are three or more different types of sacrificial filament that tear successively on upward pivoting of the flap.

13. The cover defined in claim 1, wherein the textile is provided with a coating of fleece or film.
